(19) United States
(12) Patent Application Publication
(10) Pub. No.: US 2014/0366446 A1
(43) Pub. Date: Dec. 18, 2014

(54) METHODS AND SYSTEMS FOR GAS SEPARATION

(71) Applicant: UOP LLC, Des Plaines, IL (US)

(72) Inventors: Bhargav Sharma, Niles, IL (US); Christopher B. McIlroy, Park Ridge, IL (US); Ernest James Boehm, Hanover Park, IL (US); David Farr, Hoffman Estates, IL (US); Nagaraju Palla, Woodridge, IL (US)

(21) Appl. No.: 13/918,657

(22) Filed: Jun. 14, 2013

(51) Int. Cl. B01D 53/22; B01D 53/18; C10L 3/10; B01D 53/14

(52) U.S. Cl. CPC B01D 53/229; B01D 53/1425; B01D 53/1475; B01D 53/1418; B01D 53/18; C10L 3/101; B01D 2053/224; B01D 2053/223
USPC 48/127.3; 95/172; 95/45; 95/176; 96/4; 96/10; 95/51

(57) ABSTRACT

Systems and methods for gas separation are disclosed. In one exemplary embodiment, a method for gas separation includes the steps of contacting a feed gas stream that includes a product gas and an impurity gas with a liquid-phase absorption solvent and absorbing the impurity gas and a portion of the product gas of the feed gas stream into the liquid-phase absorption solvent. The exemplary method further includes the steps of subjecting the liquid-phase absorption solvent to a first reduced pressure environment to remove the portion of the product gas and a portion of the impurity gas from the liquid-phase absorption solvent and separating the portion of the product gas from the portion of the impurity gas.

### TECHNICAL FIELD

The present disclosure generally relates to methods and systems for gas separation. More particularly, the present disclosure relates to methods and systems for separating carbon dioxide from natural gas or synthesis gas streams.

### BACKGROUND

The separation and removal of carbon dioxide (CO₂) from hydrogen or hydrocarbon-containing impure gas streams is desired, among other reasons, to improve the heating value of the gas product and to meet applicable environmental guidelines regarding CO₂ capture. Differences in a number of properties between CO₂ and hydrogen or light hydrocarbons (i.e., C₁-C₃ hydrocarbons) serve as potential bases for gas separations. These differences include solubility, acidity in aqueous solution, and molecular size and structure. Possible separations therefore rely on physical or chemical absorption into liquid solvents or pressure swing absorption with solid absorbents, for example.

Liquid solvent absorption (i.e., “wet”) systems, for example, are commonly used for gas separation to remove minor amounts of CO₂. This contaminant is preferentially absorbed in physical solvents such as dimethyl ethers of polyethylene glycol or chemical solvents such as alkanolamines or alkali metal salts. The resulting CO₂-rich (i.e., “loaded”) solvent is subsequently regenerated by pressure-based separation methods to recover both CO₂ and a regenerated solvent that may be recycled for further use in absorption. Solvent regeneration is normally conducted at a reduced pressure relative to the upstream absorption pressure, to promote vaporization of absorbed CO₂ from the solvent. Solvent absorption and solvent regeneration are usually carried out in different columns containing packing, bubble plates, or other vapor-liquid contacting devices to improve the efficiency of mass transfer between phases. The CO₂ may be recovered in more than one stream, for example in the vapor fractions of multiple pressure-based separators.

Chemical solvents, and particularly amines and other basic compounds, react with contaminant CO₂, an acid gas, to form a contaminant-solvent chemical bond. Considerable energy release is associated with this bond formation during the thermodynamically-favored, acid-base reaction. Due to the substantial heat input required to break the bonds of the heat-stable salts formed as chemical reaction products, chemical solvents are not economically regenerated. Physical solvents, on the other hand, do not react chemically with gas contaminants, but instead promote physical absorption based on a higher contaminant equilibrium solubility at its partial pressure in the impure gas (i.e., a higher Henry's law constant).

Physical solvents that remain chemically non-reactive with the impure gas stream are therefore desirable in gas separation systems due to the ease of solvent regeneration. However, one of the drawbacks of physical solvents is their tendency to co-absorb small amounts of hydrocarbons along with the CO₂. When the solvent is subsequently regenerated, the hydrocarbons are liberated from the solvent, along with the CO₂, resulting in an impure CO₂ product. Thus, prior art systems have required recycling of the impure CO₂ back to the absorption column. This impure CO₂ recycling necessitates an increase in size of the absorption column, an increase in solvent circulation rate, an increase in system cooling requirements, and an increase in solvent inventory, all of which increase the operating costs of the system in terms of utilities and materials used.

Accordingly, it is desirable to provide systems and methods for separating CO₂ from hydrogen and hydrocarbon-containing gas streams that reduce or eliminate the need for impure CO₂ recycling. It is further desirable to provide such systems and methods that reduce input costs, such as utility costs and material costs. Furthermore, other desirable features and characteristics of the present disclosure will become apparent from the subsequent detailed description and the appended claims, taken in conjunction with the accompanying drawings and this background of the disclosure.

### BRIEF SUMMARY

Systems and methods for gas separation are disclosed. In one exemplary embodiment, a method for gas separation includes the steps of contacting a feed gas stream that includes a product gas and an impurity gas with a liquid-phase absorption solvent and absorbing the impurity gas and a portion of the product gas of the feed gas stream into the liquid-phase absorption solvent. The exemplary method further includes the steps of subjecting the liquid-phase absorption solvent to a first reduced pressure environment to remove the portion of the product gas and a portion of the impurity gas from the liquid-phase absorption solvent and separating the portion of the product gas from the portion of the impurity gas.

In another exemplary embodiment, a system for gas separation includes an absorptive separation unit configured to contact a feed gas stream that includes a product gas and an impurity gas with a liquid-phase absorption solvent so as to absorb a portion of the product gas and the impurity gas into the liquid-phase absorption solvent. The system further includes a first pressure-based separation unit configured to subject the liquid-phase absorption solvent to a first reduced pressure environment so as to remove a portion of the impurity gas and the portion of the product gas from the liquid-phase absorption solvent. Still further, the system includes a membrane separation unit configured to separate the portion of the product gas from the portion of the impurity gas.

### BRIEF DESCRIPTION OF THE DRAWINGS

The gas separation systems and associated methods will hereinafter be described in conjunction with the following drawing figures, wherein like numerals denote like elements, and wherein:

FIG. 1 is a process flow diagram illustrating a method implemented on a gas separation system in accordance with various embodiments of the present disclosure;

FIG. 2 is an exemplary membrane separation system suitable for use with the method implemented on the gas separation system illustrated in FIG. 1; and

FIG. 3 is an alternate membrane separation system suitable for use with the method implemented on the gas separation system illustrate in FIG. 1.

### DETAILED DESCRIPTION

The following detailed description is merely exemplary in nature and is not intended to limit the disclosure or the application and uses of the disclosed embodiments. All of the embodiments and implementations of the gas separation systems and associated methods described herein are exemplary embodiments provided to enable persons skilled in the art to make or use the same and not to limit their scope, which is defined by the claims. Furthermore, there is no intention to be bound by any expressed or implied theory presented in the preceding technical field, background, brief summary, or the following detailed description.

Embodiments of the present disclosure are generally directed to gas separation methods in which a contaminant, present as a minor component of an impure feed gas, is selectively absorbed into a solvent. The methods advantageously recover significant portions of the impure feed gas components, including the contaminant, in purified product gas streams. Representative impure gas streams include those that contain hydrogen (H₂) and/or light hydrocarbons (e.g., C₁-C₃ hydrocarbons such as methane, ethane, and propane), and non-hydrocarbon gas contaminants, such as carbon dioxide (CO₂). Examples of such gas streams include synthesis gas, which is typically derived from the gasification or steam reforming of carbonaceous materials, and natural gas, which is typically derived from terrestrial sources. Natural gas and synthesis gas streams generally include CO₂ at contaminant levels, that is, in an amount of about 10% or less by volume, such as an amount from about 1% to about 10% by volume (the remaining about 90% or greater by volume being occupied by the hydrogen and/or hydrocarbon gasses noted above), or about 5% or less by volume. For simplicity, the illustrative embodiments are described hereinafter with respect to such hydrogen and/or hydrocarbon and CO₂ systems with the latter component being present at contaminant levels, although it will be appreciated that the disclosure is broadly applicable to the separation of impurity gasses from impure gas feeds in which the impurity gas, present in a minor amount, is preferentially absorbed into a liquid solvent, and particularly a physical solvent.

The embodiments disclosed herein further employ a membrane separation system to separate hydrocarbons from CO₂ in the impure CO₂ product that is produced from the regeneration of the physical solvent used to separate the CO₂ from the hydrogen and/or hydrocarbon-containing gas streams. By separating the hydrocarbon impurities from the CO₂ product after liberation from the solvent, it is not necessary to recycle any impure CO₂ product back to the absorption column. This, in turn, reduces the required size of the absorption column and further reduces the utility and material costs required to operate the system. The described embodiments find particular application in synthesis gas and natural gas processing and purification applications, although other implementations are possible.

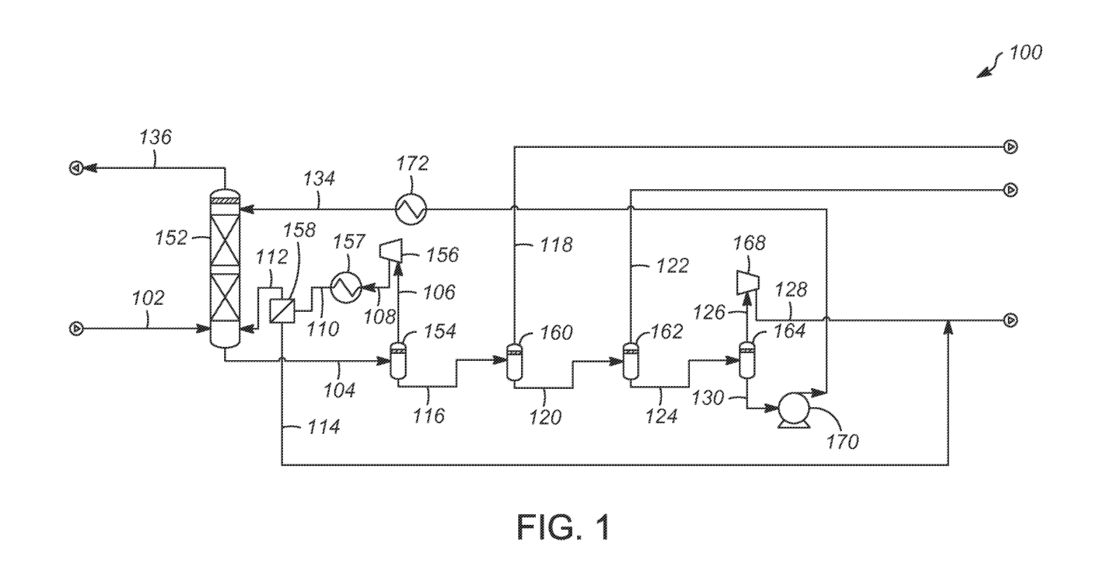

Reference is now made to FIG. 1, which is a process flow diagram illustrating a method implemented on a gas separation system 100 in accordance with various embodiments of the present disclosure. As shown, impure feed gas stream 102 that contains hydrogen and/or hydrocarbons and CO₂ at contaminant levels is provided to a counter-current absorptive separation (or “absorption”) column 152. The impure feed gas stream 102 is provided at a temperature of about 15° C. (60° F.) to about 65° C. (150° F.) and a pressure of about 21 barg (300 psig) to about 1500 barg (100 psig). In the absorption column 152, the impure feed gas flows upwardly through packed beds where it is contacted with a downwardly flowing, liquid-phase physical solvent. Representative physical solvents include dialkyl ethers of polyethylene glycol such as polyethylene glycol dimethyl ether, propylene carbonate, tributyl phosphate, methanol, tetrahydrothiophene dioxide (or tetramethylene sulfone). Others possible physical solvents include alkyl- and alkanol-substituted heterocyclic hydrocarbons such as alkanolpyridines (e.g., 3-(pyridin-4-yl)-propan-1-ol) and alkylpyrrolidones (e.g., n-methylpyrrolidone). The contact between the gas phase and liquid phase is enhanced as they each pass through the packed beds, where primarily CO₂, and some hydrocarbons and other gases, are transferred from the gas phase to the liquid phase (i.e., the gasses are absorbed into the liquid phased solvent). The treated hydrogen and/or hydrocarbon-containing gas pass through de-entrainment devices at the top of the column, where it exits system 100 as a hydrogen and/or hydrocarbon product stream 136.

Subsequent to contacting with the impure feed gas, the solvent from the CO₂ absorption column 152, which collects in the bottom of the tower, is partially or fully “rich” or “loaded” (i.e., absorbed with) with CO₂. A CO₂-rich solvent stream 104 exits at the bottom of column 152 and is routed to a first pressure-based separation system, for example a first flash separation drum 154. In the first flash separation drum 154, the CO₂-rich solvent is subjected to a first reduced pressure environment to cause some of the dissolved CO₂ and any dissolved hydrocarbons to be transferred to the gas phase. The first flash separation drum 154 generally operates at a pressure of less than or equal to about 27 barg (400 psig) (e.g., from about 2 barg (30 psig) to about 27 barg (400 psig)). In one embodiment, flash separation drum 154 operates at a pressure from about 21 barg (300 psig) to about 27 barg (400 psig).

A separated overhead gas stream 106 containing primarily CO₂ and some hydrocarbon impurities exits through an end, such as the top of first flash separation drum 154 and is routed to a compressor 156, wherein the pressure of the gas is increased to a range of about 21 barg (300 psig) to about 100 barg (1500 psig). Thereafter, a pressurized gas stream 108 (again, containing primarily CO₂ and some hydrocarbon impurities) is routed to a cooling system 157, wherein excess heat generated by compression is eliminated. The cooling system 157 reduces the temperature of the gas to a range of about 30° C. (90° F.) to about 50° C. (120° F.). Stream 110 is optionally sent to a compressor “knock-out” drum (not shown in the figures) or other suitable device to separate any liquid from the vapor phase; the gas outlet of the separator may be equipped with a mesh blanket or other suitable device to remove entrained liquids so that the membrane is not exposed to liquids.

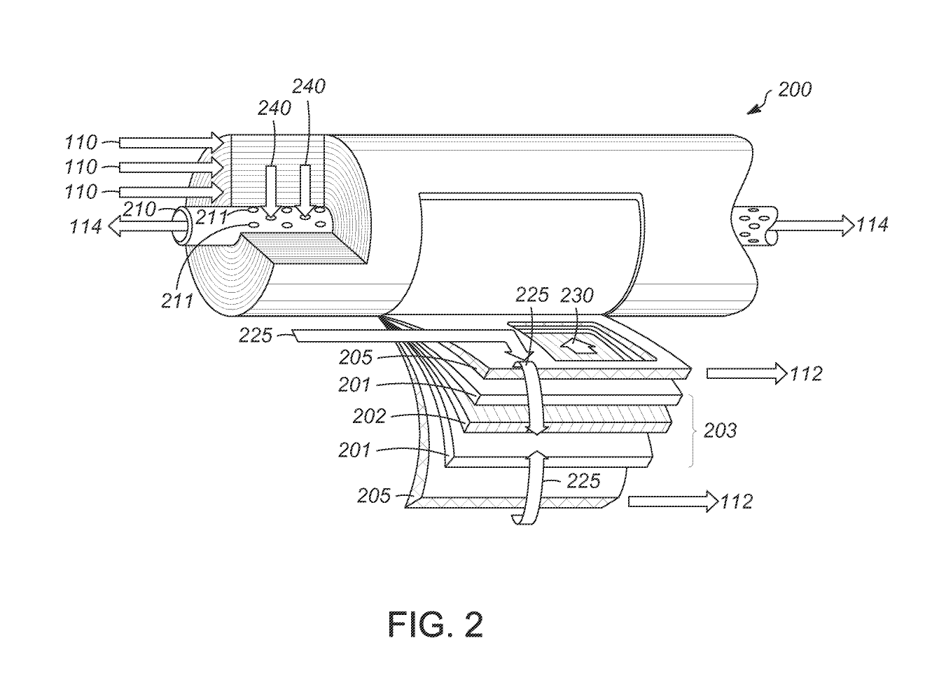

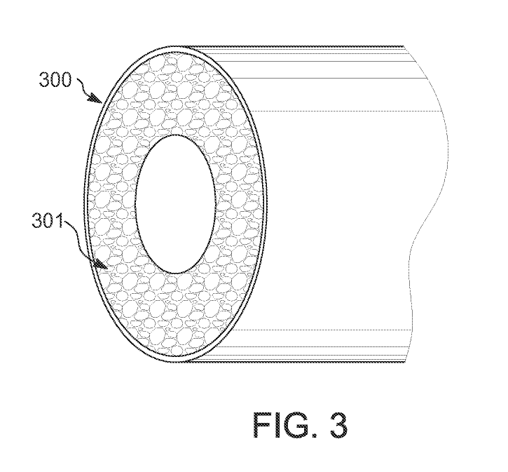

A cooled gas stream 110 from the cooling system 157 is then routed to a membrane separation system 158. As noted above, the embodiments disclosed herein employ membrane separation system 158 to separate any hydrocarbon impurities from the CO₂ in the hydrocarbon-contaminated CO₂ gas stream 106/108/110 that results from flash-separating the dissolved gasses from the loaded solvent. By separating the hydrocarbon impurities from the CO₂ product after liberation from the solvent using the membrane separation system 158, the required size of the absorption column 152 and the utility and material costs required to operate the system 100 are reduced. The structure and operation of membrane separation system 158 is described in greater detail below in connection with FIGS. 2 and 3.

Membrane separation systems for gas separation processes are generally based on the relative permeabilities of the various components of the gas mixture, resulting from a gradient of driving forces, such as pressure, partial pressure, concentration, and/or temperature. Such selective permeation results in the separation of the gas mixture into portions commonly referred to as “residual” or “retentate”, e.g., generally including the components of the mixture that permeate more slowly and “permeate”, e.g., generally including the components of the mixture that permeate more quickly.

Membranes for gas separation processes typically operate in a continuous manner, wherein a feed gas stream is introduced to the membrane separation module on a non-permeate side of a membrane. The feed gas is introduced at separation conditions that include a separation pressure and temperature that retains the components of the feed gas stream in the vapor phase, well above the dew point of the gas stream, or the temperature and pressure condition at which condensation of one of the components might occur.

Separation membranes are commonly manufactured in a variety of forms, including flat-sheet arrangements and hollow-fiber arrangements, among others. In an exemplary embodiment of the present disclosure, a flat-sheet separation membrane is novelly employed in membrane separation system 158. In a flat-sheet arrangement, the sheets are typically combined into a spiral wound element. An exemplary flat-sheet, spiral-wound membrane element 200, as depicted in FIG. 2, includes two or more flat sheets of membrane 201 with a permeate spacer 202 in between that are joined, e.g., glued along three of their sides to form an envelope 203, i.e., a “leaf”, that is open at one end. The envelopes are separated by feed spacers 205 and are wrapped around a mandrel or otherwise wrapped around a permeate tube 210 with the open ends of the envelopes facing the permeate tube 210. As shown in FIG. 2, the cooled, impure CO₂ stream 110 enters along one side of the membrane element 200 and passes through the feed spacers 205 separating the envelopes 203. As the gas travels between the envelopes 203, highly permeable compounds such as CO₂ permeate or migrate into the envelope 203, indicated by arrow 225. These permeated compounds have an available outlet: they travel within the envelope 203 to the permeate tube 210, as indicated by arrow 230. The driving force for such transport is the partial pressure differential between the low permeate pressure and the high feed pressure. The permeated compounds enter the permeate tube 210, such as through holes 211 passing through the permeate tube 210, as indicated by arrows 240. The permeated compounds then travel through the permeate tube 210, exiting as stream 114. Other membrane elements (not shown) may optionally be connected together in a multi-element assembly. Components of the gas stream 110 that do not permeate or migrate into the envelopes, i.e., the residual components such as the hydrocarbon impurities, leave the element 200 via stream 112 through the side opposite the feed side.

In one embodiment the permeate CO₂ gas, which exits the membrane separator 158 via stream 114, is available at, for example, about 5 barg (about 80 psig) to about 10 barg (about 150 psig). The residue hydrocarbon gas, which exits the membrane separator 158 via stream 112, is available at about 14 barg (about 200 psig).

FIG. 3 depicts an alternative embodiment of a membrane suitable for use in the presently described membrane separation system 158. In particular, a hollow fiber membrane structure 300 is depicted. The hollow fiber membrane structure 300 includes a plurality of hollow fibers 301 that selectively allows various gasses or liquids to permeate therethrough, depending on the design. Gas separation occurs as described above, with the CO₂ gas permeating therethrough at a rate faster than the hydrocarbon gas. The present disclosure, in alternative embodiments, may employ either or both of the spiral-wound membranes 200 noted above in FIG. 2 and the hollow fiber membranes 300 shown in FIG. 3.

In an exemplary embodiment, whether the spiral-wound membrane 200 or the hollow fiber membrane 300 is employed, the membrane may be constructed of a glassy polymer material. In one example, the glassy polymer material includes cellulose acetate. In another embodiment, the glassy polymer material includes a polyimide/per-fluoro polymer-based material.

Returning to FIG. 1, as noted above, the membrane separation system 158 separates the cooled, impure CO₂ stream 110 into a hydrocarbon-rich residue (non-permeate) stream 112 and a CO₂-rich permeate stream 114. The hydrocarbon-rich residue gas stream 112 is recycled back into the absorption column 152 to re-join the impure feed gas. The CO₂-rich permeate stream 114 is joined with a CO₂ stream generated by a further pressure-based separation system downstream of the first pressure-based separation system (i.e., flash drum 154, noted above), as will be described in greater detail below. In this manner, it is not necessary to recycle any impure CO₂ product back to the absorption column 152. This, in turn, reduces the required size of the absorption column 152 and further reduces the utility and material costs required to operate the system 100.

Returning now to the description of first flash separation drum 154, a first flashed solvent stream 116 (i.e., the solvent stream having been exposed to the reduced pressure environment of the first flash separation drum 154) exits an end, such as the bottom of the drum 154 and is routed to a second pressure-based separation system, such as a second flash separation drum 160 that operates at a lower pressure than the first flash separation drum 154. In the second flash separation drum 160, the solvent is subjected to a second reduced pressure environment to cause an additional amount of the dissolved CO₂ to be transferred to the gas phase. The second flash separation drum 160 generally operates at a pressure of less than or equal to about 21 barg (400 psig) (e.g., from about 2 barg (30 psig) to about 21 barg (300 psig)). In one embodiment, flash separation drum 160 operates at a pressure from about 14 barg (200 psig) to about 21 barg (300 psig). The second separation flash drum 160 is operated at a pressure that is less than the first flash separation drum 154 such that additional dissolved CO₂ in the solvent is caused to transfer to the gas phase. The absorbed hydrocarbons having been substantially eliminated from the solvent by the operation of the first flash separation drum 154, the second flash separation drum produces a gas phase CO₂ product stream 118 that is substantially pure.

A second flashed solvent stream 120, which exits the bottom of the drum 160, is directed to two further pressure-based separation systems, e.g. two further flash separation drums: a third, low-pressure flash separation drum 162 and a fourth, vacuum-pressure flash separation drum 164. The third flash separation drum 162 operates at a pressure that is lower than the second flash separation drum 160, and the fourth flash separation drum 164 operates at a pressure that is lower than the third flash separation drum 162. For example, the third flash separation drum 162 generally operates at a pressure of less than or equal to about 14 barg (200 psig) (e.g., from about 2 barg (30 psig) to about 14 barg (200 psig)). In one embodiment, flash separation drum 162 operates at a pressure from about 7 barg (200 psig) to about 14 barg (200 psig). Further, the fourth flash separation drum 164 generally operates at a pressure of less than or equal to about 7 barg (100 psig) (e.g., from about 2 barg (30 psig) to about 7 barg (100 psig)). A second gas phase, substantially pure CO₂ product stream 122 exits from the top of the third, low-pressure flash separation drum 162. A third flashed solvent stream 124 exits the bottom of the drum 162 and is routed to the fourth flash separation drum 164. A third gas phase, substantially pure CO₂ product stream 126 exits from the top of the fourth, vacuum-pressure flash separation drum 164. Due to the very flow pressure of the stream 126, a compressor 168 is typically provided to increase the pressure of CO₂ product stream 126. Thus, a compressed CO₂ product stream 128 is produced by compressor 168. As alluded to above, the CO₂-rich permeate stream 114 is joined with the compressed CO₂ product stream 128 generated by the fourth, vacuum-pressure flash drum 164.

Although a series of four pressure-based separation systems, e.g. a series of four flash separation drums 154, 160, 162, and 164 are illustrated in system 100, it will be appreciated by those having ordinary skill in the art that more or fewer pressure-based separation systems may be provided in an embodiment. For example, the system 100 may alternatively be provided with one, two, three, or more than four pressure-based separation systems, as may be desired for a given system implementation. It will be appreciated that the more pressure-based separation systems that are provided, the more complete the regeneration of the absorption solvent (i.e., the more complete the removal of absorbed CO₂ gas therefrom) will be.

A fourth flashed solvent stream 130 exits the bottom of the drum 164 and is routed to a pumping system 170 that delivers the semi-lean (i.e., having at least a portion of the absorbed CO₂ removed therefrom) solvent to a cooling system 172. The cooling system 172 reduces the temperature of the stream 130 and produces a cooled, semi-lean solvent stream 134 that is recycled back to the absorption column 152 for use in further gas separations. Cooled, semi-lean solvent stream 134 may be combined with an optional make-up solvent stream (not shown) to provide a solvent stream that is introduced into absorption column 152 as described above. The optional make-up solvent stream replaces the total solvent losses throughout the gas separation system 100.

As such, the present disclosure provides various exemplary embodiments of methods and systems for gas separation that employ a membrane separation system to reduce or eliminate the need for impurity-containing product stream recycling. The described embodiments allow for a reduction in size of the required gas separation column, a reduction in solvent circulation rate, a reduction in system cooling requirements, and a reduction in solvent inventory, all of which reduce the operating costs of the system.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes may be made in the processes without departing from the scope defined by the claims, which includes known equivalents and foreseeable equivalents at the time of this disclosure.

What is claimed is:

1. A method for gas separation comprising the steps of:
contacting a feed gas stream comprising a product gas and an impurity gas with a liquid-phase absorption solvent;
absorbing the impurity gas and a portion of the product gas of the feed gas stream into the liquid-phase absorption solvent;
subjecting the liquid-phase absorption solvent to a first reduced pressure environment to remove the portion of the product gas and a portion of the impurity gas from the liquid-phase absorption solvent; and
separating the portion of the product gas from the portion of the impurity gas.

2. The method of claim 1, wherein contacting the feed gas stream with the liquid-phase absorption solvent comprises contacting the feed gas stream with a physical absorption solvent.

3. The method of claim 1, wherein contacting the feed gas stream with the liquid-phase absorption solvent comprises contacting a gas stream comprising about 95% or greater by volume hydrogen and/or hydrocarbon gasses and about 5% or less by volume carbon dioxide impurity gas with the liquid-phase absorption solvent.

4. The method of claim 3, wherein absorbing the impurity gas and the portion of the product gas comprises absorbing the carbon dioxide gas and a portion of the hydrocarbon gas.

5. The method of claim 1, wherein subjecting the liquid-phase absorption solvent to the first reduced pressure environment comprises subjecting the liquid-phase absorption solvent to a pressure of about 27 barg or less.

6. The method of claim 1, wherein separating the portion of the product gas from the portion of the impurity gas comprises permeating the portion of the impurity gas in a permeation membrane at a faster rate than the portion of the product gas.

7. The method of claim 1, further comprising the step of recycling the portion of the product gas to re-join the feed gas stream.

8. The method of claim 1, further comprising the step of subjecting the liquid-phase absorption solvent to a second reduced pressure environment to remove a further portion of the impurity gas from the liquid-phase absorption solvent.

9. The method of claim 8, wherein subjecting the liquid-phase absorption solvent to the second reduced pressure environment comprises subjecting the liquid-phase absorption solvent to a pressure of about 21 barg or less.

10. A system for gas separation comprising:
an absorptive separation unit configured to contact a feed gas stream comprising a product gas and an impurity gas with a liquid-phase absorption solvent so as to absorb a portion of the product gas and the impurity gas into the liquid-phase absorption solvent;
a first pressure-based separation unit configured to subject the liquid-phase absorption solvent to a first reduced pressure environment so as to remove a portion of the impurity gas and the portion of the product gas from the liquid-phase absorption solvent; and
a membrane separation unit configured to separate the portion of the product gas from the portion of the impurity gas.

11. The system of claim 10, wherein the absorptive separation unit comprises a packed bed, counter-current flow absorption column.

12. The system of claim 10, wherein the first pressure-based separation unit comprises a flash separation drum.

13. The system of claim 10, wherein the membrane separation unit comprises a spiral-wound membrane.

14. The system of claim 10, wherein the membrane separation unit comprises a hollow fiber membrane.

15. The system of claim 1, wherein the first pressure-based separation unit is configured to subject the liquid-phase absorption solvent to a pressure of about 27 barg or less.

16. The system of claim 15, further comprising a second pressure-based separation unit configured to subject the liquid-phase absorption solvent to a second reduced pressure environment having a pressure that is lower than the first reduced pressure environment so as to remove a further portion of the impurity gas from the liquid-phase absorption solvent.

17. The system of claim 16, wherein the second pressure-based separation unit is configured to subject the liquid-phase absorption solvent to a pressure of about 21 barg or less.

18. The system of claim 10, further comprising a compressor configured to compress the portion of the impurity gas and the portion of the product gas after removal thereof from the liquid-phase absorption solvent and a cooling system configured to cool the portion of the impurity gas and the portion of the product gas after compression in the compressor.

19. A method for gas separation comprising the steps of:
contacting a feed gas stream comprising a hydrogen and/or hydrocarbon product gas and a carbon dioxide impurity gas with a liquid-phase physical absorption solvent;
absorbing the impurity gas and a portion of the product gas of the feed gas stream into the liquid-phase physical absorption solvent;
subjecting the liquid-phase absorption solvent to a first reduced pressure environment to remove a portion of the impurity gas and the portion the product gas from the liquid-phase physical absorption solvent;
separating the portion of the product gas from the portion of the impurity gas by permeating the portion of the impurity gas in a permeation membrane at a faster rate than the portion of the product gas;
recycling the portion of the product gas to re-join the feed gas stream; and
subjecting the liquid-phase absorption solvent to a second reduced pressure environment to remove a further portion of the impurity gas from the liquid-phase physical absorption solvent.

20. The method of claim 19, wherein contacting the feed gas stream comprising a hydrogen and/or hydrocarbon product gas with the liquid-phase physical absorption solvent comprises contacting a synthesis gas stream or a natural gas stream with the liquid-phase physical absorption solvent.
